(19) United States
(12) Patent Application Publication
(10) Pub. No.: US 2015/0211826 A1
(43) Pub. Date: Jul. 30, 2015

(54) AIRBAG WATER-SPRAYING GAME APPARATUS

(71) Applicant: CHIN-YIH CHEN, NEW TAIPEI CITY (TW)

(72) Inventor: CHIN-YIH CHEN, NEW TAIPEI CITY (TW)

(21) Appl. No.: 14/102,528

(22) Filed: Jan. 27, 2014

(51) Int. Cl. F41B 9/00; B05B 11/02

(52) U.S. Cl. CPC F41B 9/0037; B05B 11/02

(57) ABSTRACT

An airbag water-spraying game apparatus contains: a hollow tube, a movable member, and an air bag. The hollow tube includes a first cover disposed on a first end thereof and a second cover mounted on a second end thereof, the first cover has a first hole for spraying water, and the second cover has a second hole. The movable member slidably is fixed in the hollow tube and includes a piston, a shaft, and at least one leakproof ring fitted on the piston, the shaft has a first end connecting with the piston, a second end extending out of the second hole, and a grip arranged on the second end of the shaft. The air bag is fitted on the hollow tube and includes at least one air chamber defined therein, the air bag also includes an inflatable mouth communicating with the at least one air chamber air bag.

### FIELD OF THE INVENTION

The present invention relates to an airbag water-spraying game apparatus which has a floating force and decreases its size to be portable conveniently.

### BACKGROUND OF THE INVENTION

U.S. Pat. No. 5,992,697 discloses that a water squirting device contains a hollow tub and a grip, and the hollow tube has a strap for carrying the water squirting device on user's back. However, the water squirting device and its grip are so rigid that will hurt the user.

Another conventional squirting toy is disclosed in U.S. Pat. No. 7,281,642 and includes a flexible sleeve fitted thereon, and the sleeve is foam molded from polyethylene material or ethylene vinyl acetate (EVA) material so as to provide buoyancy force and softness. Also, a dyestuff is mixed with polyethylene material or ethylene vinyl acetate (EVA) material. But such a sleeve made of polyethylene material or ethylene vinyl acetate (EVA) material occupies a large volume of the squirting toy, thus increasing transportation cost and storage space. In addition, the dyestuff will case toxic gases or substances in manufacturing process.

The present invention has arisen to mitigate and/or obviate the afore-described disadvantages.

### SUMMARY OF THE INVENTION

The primary object of the present invention is to provide an airbag water-spraying game apparatus which has a floating force and aesthetics appearance and decreases its size to be portable conveniently.

Another object of the present invention is to provide an airbag water-spraying game apparatus which will not cause toxic gases or substances in manufacturing process and obtain environmental protection.

To obtain the above objectives, an airbag water-spraying game apparatus provided by the present invention contains: a hollow tube, a movable member, and an air bag.

The hollow tube includes a first cover disposed on a first end thereof and a second cover mounted on a second end thereof, the first cover has a first hole for spraying water, and the second cover has a second hole formed thereon.

The movable member is slidably fixed in the hollow tube and includes a piston, a shaft, and at least one leakproof ring fitted on the piston. The shaft has a first end connecting with the piston, a second end extending out of the second hole of the second cover, and a grip arranged on the second end of the shaft.

The air bag includes at least one air chamber defined therein and an inflatable mouth communicating with the at least one air chamber air bag.

### BRIEF DESCRIPTION OF THE DRAWINGS

FIG. 1 is a perspective view showing the exploded components of an airbag water-spraying game apparatus according to a first embodiment of the present invention.

FIG. 2 is a perspective view showing the assembly of the airbag water-spraying game apparatus according to the first embodiment of the present invention.

FIG. 3 is a cross sectional view showing the assembly of the airbag water-spraying game apparatus according to the first embodiment of the present invention.

FIG. 4 is a perspective view showing the exploded components of an airbag water-spraying game apparatus according to a second embodiment of the present invention.

FIG. 5 is a side plan view showing the assembly of an air bag of an airbag water-spraying game apparatus according to a third embodiment of the present invention.

FIG. 6 is a top plan view showing the assembly of plural sheet-shaped air bags of an airbag water-spraying game apparatus according to a fourth embodiment of the present invention.

FIG. 7 is a cross sectional view showing the operation of the airbag water-spraying game apparatus according to the first embodiment of the present invention.

FIG. 8 is a perspective view showing the assembly of an airbag water-spraying game apparatus according to a fifth embodiment of the present invention.

### DETAILED DESCRIPTION OF THE PREFERRED EMBODIMENTS

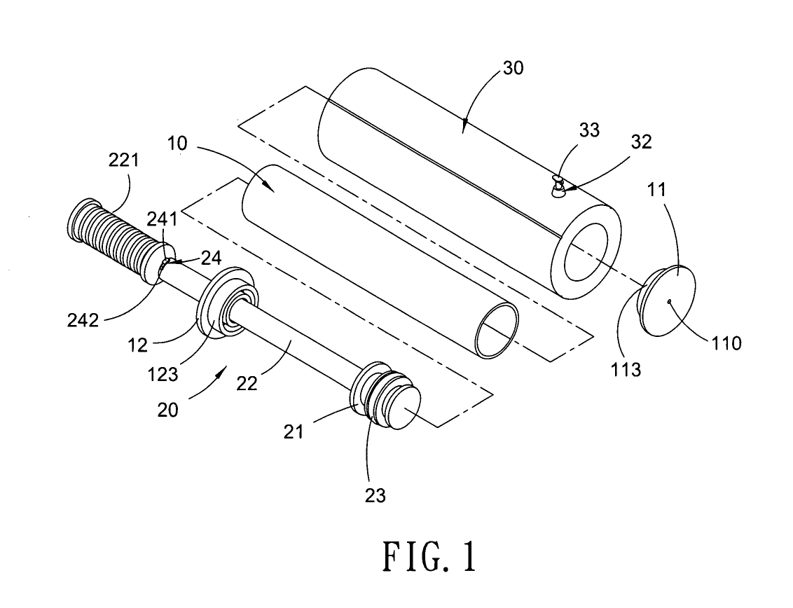

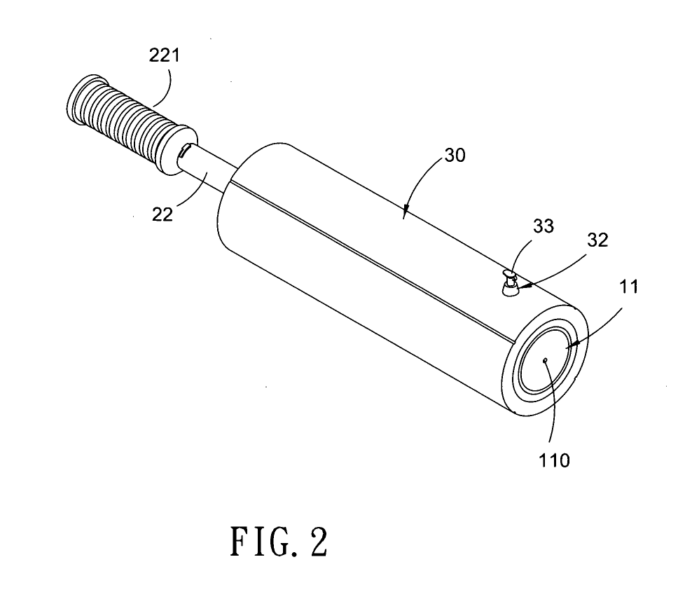

Referring further to FIGS. 1 and 2, an airbag water-spraying game apparatus according to a first embodiment of the present invention comprises:

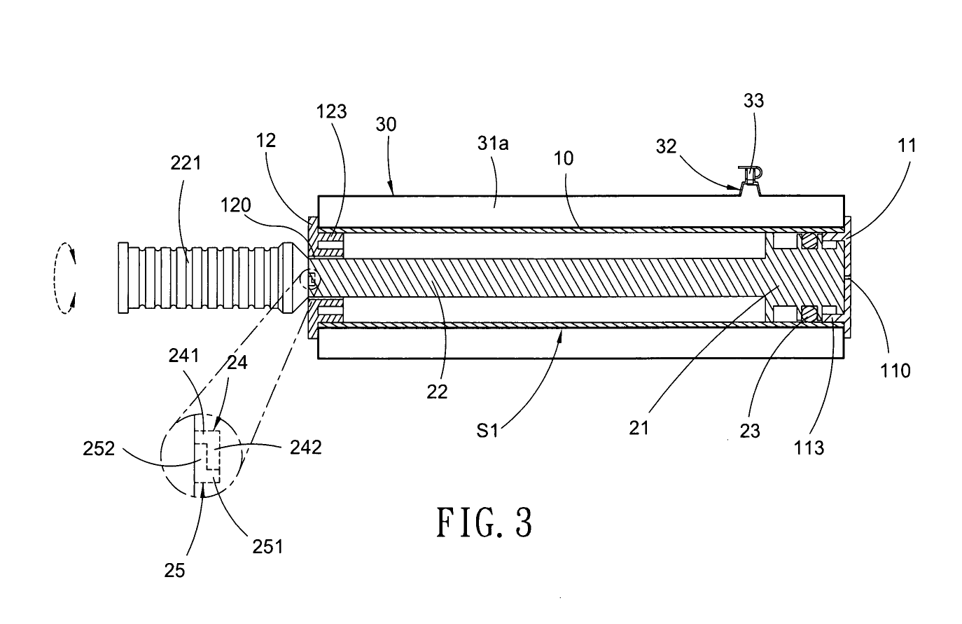

a hollow tube 10 including a first cover 11 disposed on a first end thereof and a second cover 12 mounted on a second end thereof, the first cover 11 has a first hole 110 for spraying water and a first small-diameter section 113, and the second cover 12 has a second hole 120 and a second small-diameter section 123 (as shown in FIG. 3), such that the first small-diameter section 113 and the second small-diameter 123 are fitted with the hollow tube 10, and among the hollow tube 10, the first cover 11 and the second cover 12 is defined an accommodation room S1;

a movable member 20 slidably fixed in the hollow tube 10 and including a piston 21, a shaft 22, and at least one leakproof ring 23 fitted on the piston 23, the shaft 22 has a first end connecting with the piston 21, a second end extending out of the second hole 120 of the second cover 12, and a grip 221 arranged on the second end of the shaft 22;

an air bag 30 formed in a hollow pouch shape and blow molded from plastic material, the air bag 30 including an outer surface on which patterns are printed or pigment coated, the air bag 30 being fitted on the accommodation room S1 beside the hollow tube 10 and closed by the first cover 11 and the second cover 12 and also including at least one air chamber 31a defined therein (as illustrated in FIG. 3), the air bag 30 further including an inflatable mouth 32 communicating with the at least one air chamber 31a and having at least one plug 33 or a check valve (not shown) for closing the inflatable mouth 32.

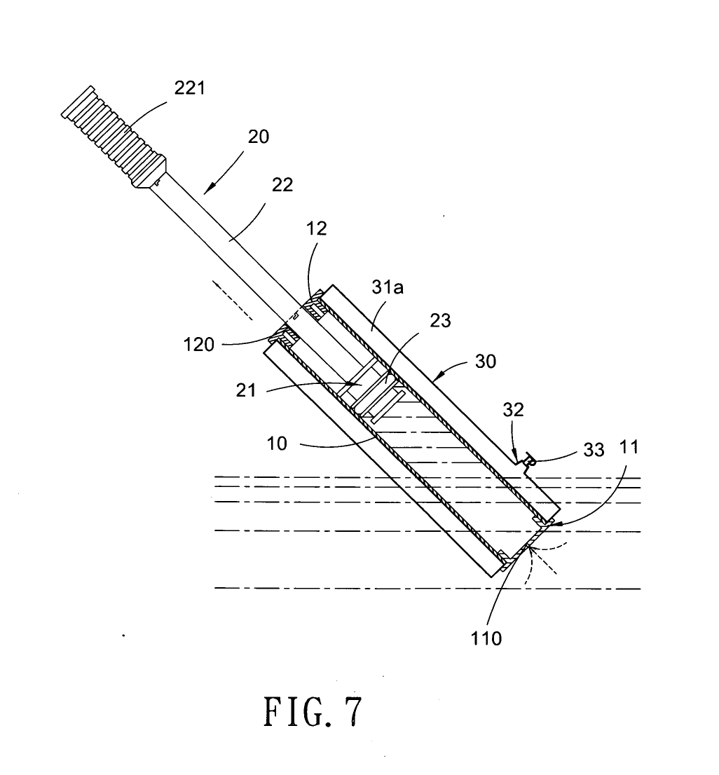

In use, the air is fed into the air chamber 31a of the air bag 30 from the inflatable mouth 32 so that an airbag water-spraying game apparatus has a flexible appearance and a floating force, when the first cover 11 of the hollow tube 10 is soaked in water, the grip 221 is pulled backward so as to drive the piston 21 to move toward the second cover 12, and the water is drawn into the hollow tube 10 from the first hole 110 of the first cover 11 (as shown in FIG. 7), thereafter the grip 221 is pushed toward the first cover 11 so that the water in the hollow tube 10 is sprayed out of the first hole 110.

The air bag 30 is made of PVC resin and can be separated from the hollow tube 10. For example, in FIG. 1, the air bag 30 is formed in a tube shape and is fitted on the hollow tube 10 so that the air bag 30 is removed from the hollow tube 10 and washed further, thus cleaning the airbag water-spraying game apparatus.

In the first embodiment, the first cover 11 is used to close the first end of the hollow tube 10, and the second cover 12 is applied to close the second end of the hollow tube 10 in an gluing manner (as shown in FIG. 1).

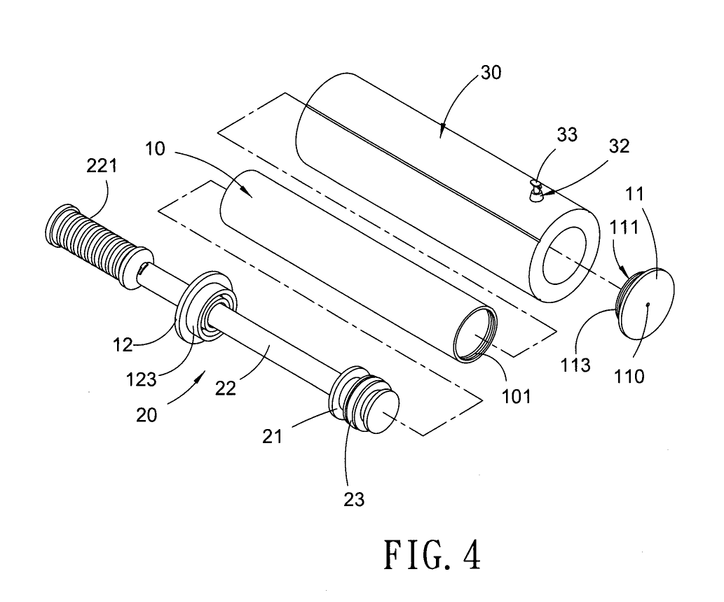

In a second embodiment, a first cover 11 is disposed on a first end of a hollow tube 10, and a second cover 12 is mounted on a second end of the hollow tube 10 in a screwing manner (as shown in FIG. 4), wherein the first cover 11 has a peg 111 with outer threads 112, and the first end of the hollow tube 10 has inner threads 101 for screwing with the outer threads 112 of the peg 111, such that the first cover 11 is removed from the hollow tube 10 by unscrewing the outer threads 112 from the inner threads 101 of the hollow tube 10 (as illustrated in FIG. 4) so as to replace another type of air bag.

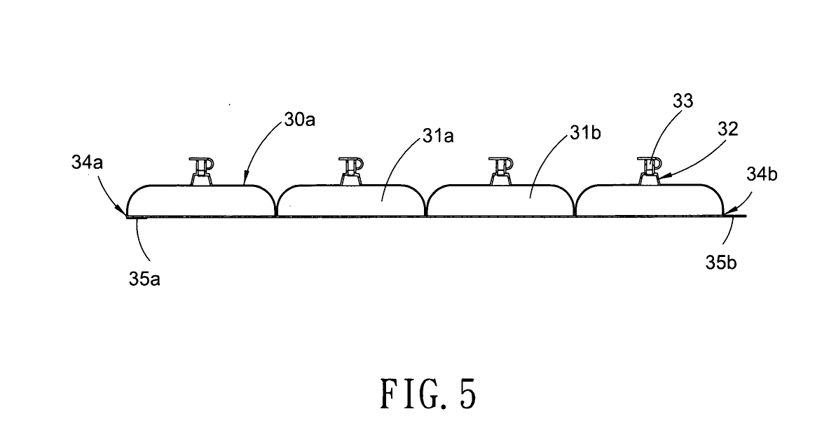

The air bag 30 has a single air chamber 31a (as shown in FIG. 1) or a plurality of air chambers 31a, 31b of a third embodiment (as illustrated in FIG. 5), wherein a respective one of the plurality of air chambers 31a, 31b has an inflatable mouth 32 and any one of the plug 33 and the check valve for closing the inflatable mouth 32. Thereby, when one of the plurality of air chambers 31a and 31b is broken or the air is released, other air chambers 31a, 31b still can be used.

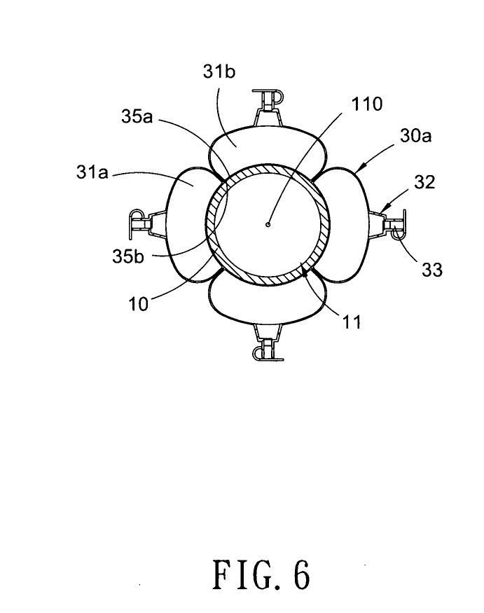

In a fourth embodiment, plural sheet-shaped air bags 30a are arranged around an outer peripheral side of the hollow tube 10 (as illustrated in FIG. 6), wherein each sheet-shaped air bag 30a has a first side 34a and a second side 34b, and the first side 34a has a first connecting element 35a, the second side 34b has a second connecting element 35b. In this embodiment, the first connecting element 35a and the second connecting element 34b are a fastening tape or are welded on the first side 34a and the second side 34b, such that the first side 34a and the second side 34b are connected together by ways of the first connecting element 35a and the second connecting element 35b after feeding air into the plural sheet-shaped air bags 30a, and then the plural sheet-shaped air bags 30a are fixed onto the hollow tube 10. Also, the plural sheet-shaped air bags 30a are removed from the hollow tube 10, and the air in the plural sheet-shaped air bags 30a is released so as to wash or to store the plural sheet-shaped air bags 30a in a small size.

Referring to FIG. 3, the airbag water-spraying game apparatus further comprises a locking structure, and the locking structure contains a first fastener 24 disposed on a shaft 22 of a movable member 20 and a second fastener 25 mounted on an inner wall of a hollow tube 10, such that the first fastener 24 locks with the second fastener 25 so that the movable member 20 connects with or disconnects from the hollow tube 19. As shown in FIG. 3, the first fastener 24 is close to a grip 221 and has a first extension 241 and a first bending section 242, wherein the first extension 241 extends to the hollow tube 10 from the grip 221, and the first bending section 242 couples with the first extension 241 and bends toward a first direction which is a clockwise direction or a counterclockwise around a central axle of the shaft 22. The second fastener 25 has a second extension 251 and a second bending section 252, wherein the second extension 251 extends to the grip 221 from the hollow tube 10, and the second bending section 252 connects with the second extension 241 and bends toward a second direction which is a clockwise direction or a counterclockwise around the central axle of the shaft 22, wherein the first direction is opposite to the second direction. Accordingly, when the grip 221 of the movable member 20 and the hollow tube 10 are rotated, the first fastener 24 fastens or unfastens the second fastener 25.

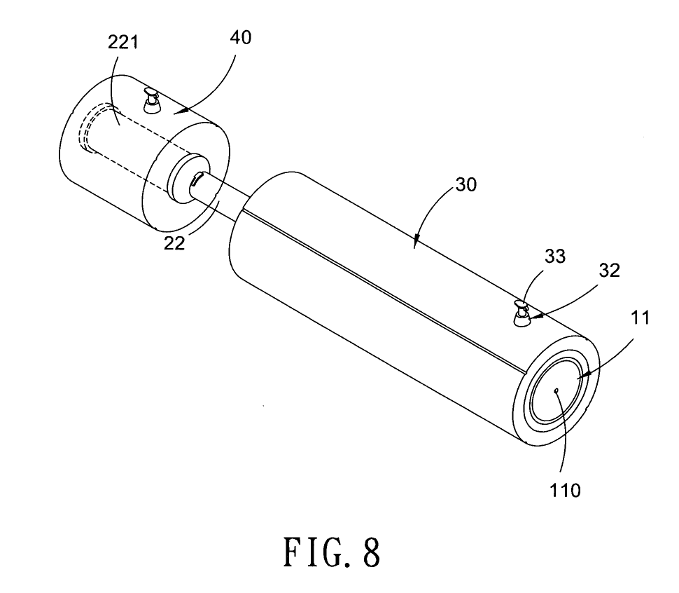

With reference to FIG. 8, an airbag water-spraying game apparatus according to a fifth embodiment of the present invention comprises: a second air bag 40 fitted on the grip 221 of the movable member 20, and the second air bag 40 is removable like the air bag 30 of the first embodiment or the plural sheet-shaped air bags 30a of the third embodiment.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. An airbag water-spraying game apparatus comprising:
a hollow tube including a first cover disposed on a first end thereof and a second cover mounted on a second end thereof, the first cover having a first hole for spraying water, and the second cover having a second hole formed thereon;
a movable member slidably fixed in the hollow tube and including a piston, a shaft, and at least one leakproof ring fitted on the piston, the shaft having a first end connecting with the piston, a second end extending out of the second hole of the second cover, and a grip arranged on the second end of the shaft;
an air bag formed in a hollow pouch shape and including at least one air chamber defined therein and an inflatable mouth communicating with the at least one air chamber air bag.

2. The airbag water-spraying game apparatus as claimed in claim 1, wherein plural sheet-shaped air bags are arranged around an outer peripheral side of the hollow tube, and each sheet-shaped air bag has a first side and a second side, the first side has a first connecting element, the second side has a second connecting element, such that the first side and the second side are connected together by ways of the first connecting element and the second connecting element after the plural sheet-shaped air bags are fixed onto the hollow tube.

3. The airbag water-spraying game apparatus as claimed in claim 1, wherein the first connecting element and the second connecting element are a fastening tape or are welded on the first side and the second side.

4. The airbag water-spraying game apparatus as claimed in claim 1, wherein the first cover has a peg with outer threads, and the first end of the hollow tube has inner threads for screwing with the outer threads of the peg.

5. The airbag water-spraying game apparatus as claimed in claim 1, wherein the air bag is fitted on the hollow tube.

6. The airbag water-spraying game apparatus as claimed in claim 5, wherein a respective one of the at least one air chamber has an inflatable mouth.

7. The airbag water-spraying game apparatus as claimed in claim 1 further comprising a locking structure, and the locking structure containing a first fastener disposed on the shaft of the movable member and a second fastener mounted on an inner wall of the hollow tube, wherein the first fastener is close to a grip and has a first extension and a first bending section, the first extension extends to the hollow tube from the grip, and the first bending section couples with the first extension and bends toward a first direction which is a clockwise direction or a counterclockwise around a central axle of the shaft; the second fastener has a second extension and a second bending section, the second extension extends to the grip from the hollow tube, and the second bending section connects with the second extension and bends toward a second direction which is a clockwise direction or a counterclockwise around the central axle of the shaft, and wherein the first direction is opposite to the second direction.

8. The airbag water-spraying game apparatus as claimed in claim 1 further comprising a second air bag fitted on the grip of the movable member.

9. The airbag water-spraying game apparatus as claimed in claim 1, wherein the inflatable mouth is closed by any one of a plug and the check valve.

10. The airbag water-spraying game apparatus as claimed in claim 1, wherein the inflatable mouth is closed by any one of a plug and the check valve.

11. The airbag water-spraying game apparatus as claimed in claim 1, wherein the first cover also has a first small-diameter section, and the second cover also has a second small-diameter section, such that the first small-diameter section and the second small-diameter are fitted with the hollow tube, and among the hollow tube, the first cover and the second cover is defined an accommodation room.
